(19) United States
(12) Patent Application Publication
(10) Pub. No.: US 2004/0011096 A1
(43) Pub. Date: Jan. 22, 2004

(54) Theft deterrent-device for ATV'S (all terrain vehicles)

(76) Inventors: Brian Paul Quinn, Raleigh, NC (US); Jackie Lee Moore, Benson, NC (US); Mitchel E. Mann, Pittsboro, NC (US)

Correspondence Address: Brian Quinn, 725 South Meadow Road, Raleigh, NC, 27603, US

(21) Appl. No.: 10/271,997

(22) Filed: Oct. 17, 2002

Related U.S. Application Data
(60) Provisional application No. 60/329,994, filed on Oct. 18, 2001.

(51) Int. Cl. B62H 5/00; E05B 71/00

(52) U.S. Cl. 70/234

(57) ABSTRACT

A method of securing an ATV or any device that allows for connection with the invention. The invention, known as Sureloc, has a five axis articulating head design which allows for connection with a device in any direction. The Auger section of Sureloc allows for securing a device into the ground without assistance from other objects. This allows Sureloc to be used as a portable security device. The shaft of Sureloc has a vertical movement of approximately 6″ as an adjustment to reach various heights of different devices. The shad guide rotates 180 degrees giving Sureloc a 2′ attachment range in a 360 degree area.

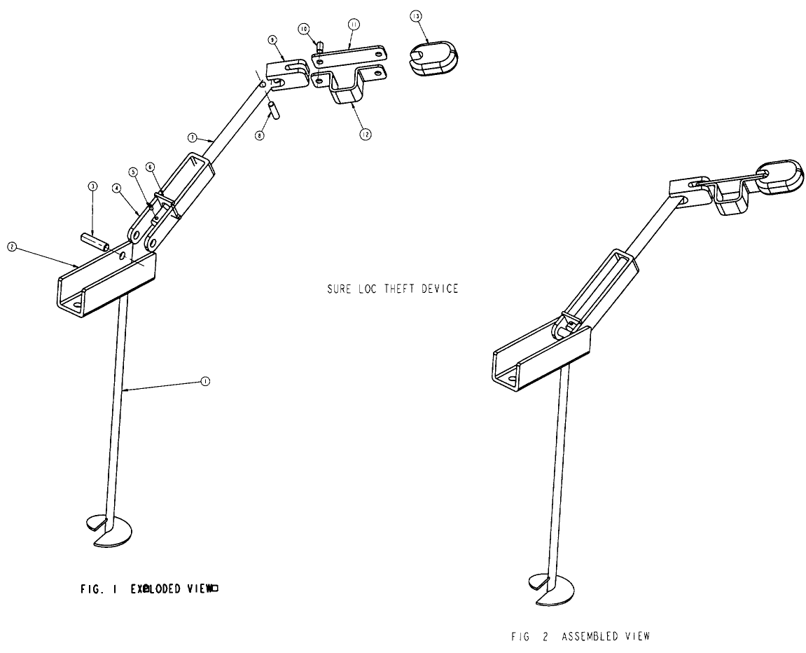

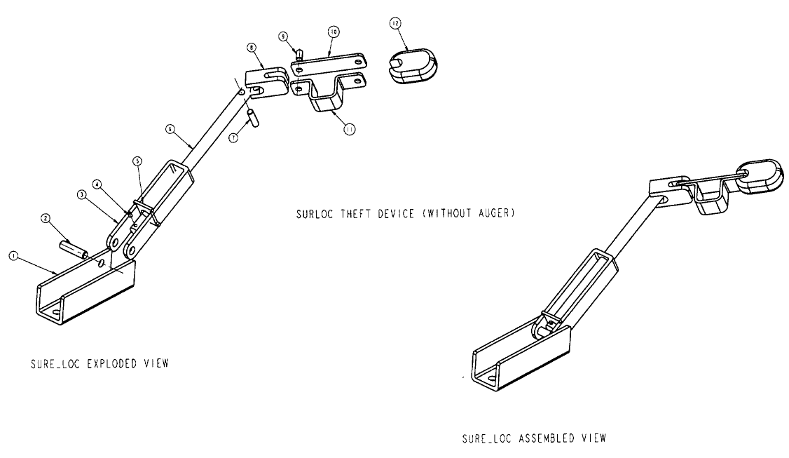

### FIELD OF THE INVENTION

The present invention is intended as a theft deterrent device for ATV's (All Terrain Vehicles), but it is not limited to ATV's, (i.e.) motorcycles, riding lawn mowers, bicycles, trailers, or any device that allows for a connection with the invention known henceforth in this document as Sureloc.

### BACKGROUND OF THE INVENTION

Most theft deterrent devices for these types of vehicles consist of securing the device with a chain and lock or locking the device inside of a shed or a storage building. While the foregoing methods provide some protection, an improved and more convenient protection method is needed.

### BRIEF DESCRIPTION OF THE DRAWING

Number 1 is a side view of the auger according to further embodiments of the present invention in the exploded view;

Number 2 is a side-angled view of the auger bracket forming a part of the connection assembly of Number 1;

Number 3 is a side view of the pivot pin according to further embodiments of the present invention in the exploded view;

Number 4 is a side-angled view of the shaft guide forming a part of the connection assembly of Number 2;

Number 5 is a side-angled view of the slide stop according to further embodiments of the present invention in the exploded view;

Number 6 is a side-angled view of the shaft slide, forming a part of the connection assembly of Number 7 to Number 4.

Number 7 is a side view of the shaft according to the further embodiments of the present invention in the exploded view;

Number 8 is a side-angled view of the pivot pin according to further embodiments of the present invention in the exploded view;

Number 9 is a side-angled view of the pivot knuckle, forming a part of the connection assembly of Number 7.

Number 10 is a side-angled view of the pivot pin according to further embodiments of the present invention in the exploded view;

Number 11 is a side view of the top clamp according to further embodiments of the present invention in the exploded view;

Number 12 is a side-angled view of the bottom clamp, forming a part of the connection assembly of Number 11, also forming apart of the connection of Number 9.

Number 13 is a side-angled view of the lock, forming a part of the connection assembly of Number 11 to Number 12.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be constructed as limited to the embodiments set forth herein; rather, these embodiments are provided so that this disclosure will be thorough and complete, and will fully convey the scope of the invention. In the drawings, like numbers refer to like elements throughout.

Auger 1 according to the embodiment of the present invention is made of a cold roll steel rod with one auger attached by weld-ment, starting approximately 2″ up from the bottom as shown in the exploded view of the accompanying drawing. Auger 1 is may be dipped in yellow chromate or painted.

Auger bracket 2 according to the embodiment of the present invention is made of 0.250 thick commercial steel, flat across the bottom with the 2 sides bent at a 90 degree angle as shown in the exploded view of the accompanying drawing. Auger bracket 2 is preferably attached to Auger 1 by a weld-ment, as shown in the assembled view of the accompanying drawing. Auger bracket 2 is preferably dipped in a yellow chromate solution and painted to prevent rusting.

The Pivot Pin 3 according to the embodiment of the present invention is preferably made of a hardened steel. Pivot Pin 3 is inserted into the Auger Bracket 2 through the Shaft Guide 4 completing a connection. Shaft Guide 4 is preferably made of a 0.250 thick commercial steel. Shaft Guide 4 can now pivot 180 degrees inside of Auger Bracket 2.

Shaft 7 is preferably made of a 0.250 thick commercial steel. Shaft 7 is placed through Shaft Guide 4. Shaft Slide 6 is placed over the end of Shaft 7. Pivot Pin 5 is inserted into Shaft 7 to prevent Shaft Slide 6 from sliding off, as shown in the assembled view of the accompanying drawing. Shaft Slide 6 is free floating on Shaft 7. Shaft Slide 6 slides up and down Shaft Guide 4 as Shaft 7 is extended and retracted. Shaft 7 can rotate 360 degrees

Pivot knuckle 9 according to the embodiment of the present invention is preferably made of A2 steel Pivot knuckle 9 is attached to Shaft 7 with Pivot Pin 8. Pivot knuckle 9 can now pivot 180 degrees.

Top Clamp 11, and Bottom Clamp 12 according to the embodiment of the present invention is preferably made from 0.250 thick commercial steel. Top Clamp 11 and Bottom Clamp 12 is inserted into Pivot Knuckle 9. Pivot Pin 10 is inserted through Pivot Knuckle 9, Top Clamp 11, and Bottom Clamp 12 making a connection as shown in the assembled view of the accompanying drawings. Top Clamp 11 and Bottom Clamp 12 can rotate 180 degrees independently of each other.

Lock 13 according to the embodiments of the present invention is preferably hardened with a shrouded shank. Lock 13 is placed over the Top Clamp 11 and the Bottom Clamp 12 and locked.

The assembled view shows all embodiments of the present invention on connections with its intended form The present invention has a 5-axis articulating head design, allowing for connection to devices from virtually any angle. The Auger 1 allows for anchoring the invention into any type soil, which makes it moveable to different locations and not able to be moved when it is attached to the object to be secured. The second drawing shows the assembly without the Auger 1. and is declared as the same invention with a different mounting style, (ie) Concrete mount, wall mount, trailer mount and truck mount.

The assembled view is illustrative of the present invention and is not to be construed as a limiting factor. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A method of securing an ATV (All Terrian Vehicels) or any device that allows for a connection with the invention, Intended as a theft deterrent device.

2. A method according to claim 1 whereas the connection with the invention secures the ATV or any device without support from other objects.

3. A method according to claim 1 where the invention has five axis of rotation allowing for a connection in all directions.

4. A method according to claim 1 where the invention is portable, allowing the invention to be moved from one location to another.
